(19) United States
(12) Patent Application Publication
(10) Pub. No.: US 2013/0294024 A1
(43) Pub. Date: Nov. 7, 2013

(54) DATA STORAGE DEVICE ASSEMBLY

(71) Applicants: HONG FU JIN PRECISION INDUSTRY (WUHAN) CO., LTD., Wuhan (CN); HON HAI PRECISION INDUSTRY CO., LTD., New Taipei (TW)

(72) Inventors: SHU-QIU WANG, Wuhan (CN); HENG TAO, Wuhan (CN); XUE-JIAO GUO, Wuhan (CN); SONG-LING YU, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/758,007

(22) Filed: Feb. 4, 2013

(30) Foreign Application Priority Data
May 2, 2012 (CN) 201210131590.2

(51) Int. Cl. G06F 1/16; A47B 96/06

(52) U.S. Cl. CPC G06F 1/16; A47B 96/06
USPC 361/679.31; 248/222.41

(57) ABSTRACT

A data storage device assembly includes a bracket and a data storage device. The bracket includes a top plate and a bottom plate. The top plate and the bottom plate each defines a first engaging slot. A first positioning post is located on the bottom plate. The data storage device includes a top wall, a bottom wall, a first sidewall and a second sidewall. A latch portion is located on each of the first sidewall and the second sidewall. A first distance is defined between the latch portion and the top wall. A second distance is defined between the latch portion and the bottom wall. The first distance is greater than the second distance. When the storage is positioned in portrait orientation, each latch portion is slidably engaged in each first engaging slot, and the first positioning post abuts against the bottom wall.

### BACKGROUND

1. Technical Field

The present disclosure relates to data storage device assemblies, and particularly to a data storage device assembly positioning means.

2. Description of Related Art

In a computer or server, a data storage device, such as a CD-ROM drive, is simply screwed to a bracket before installing to the computer enclosure. Because of symmetric construction of the data storage device, workers often assemble the data storage in the bracket in a wrong direction. For example, with the CD-ROM face down.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a data storage device assembly, the data storage comprising a data storage device and a bracket.

FIG. 2 is an enlarged view of the circled portion II of FIG. 1.

FIG. 3 is an enlarged view of the circled portion III of FIG. 1.

FIG. 4 is an assembled view of the data storage device and the bracket of FIG. 1.

FIG. 5 is another assembled view of FIG. 1, and three data storage devices are received in a landscape orientation

FIG. 6 is another assembly of FIG. 3, and the three data storage devices are received in the bracket in a portrait orientation.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

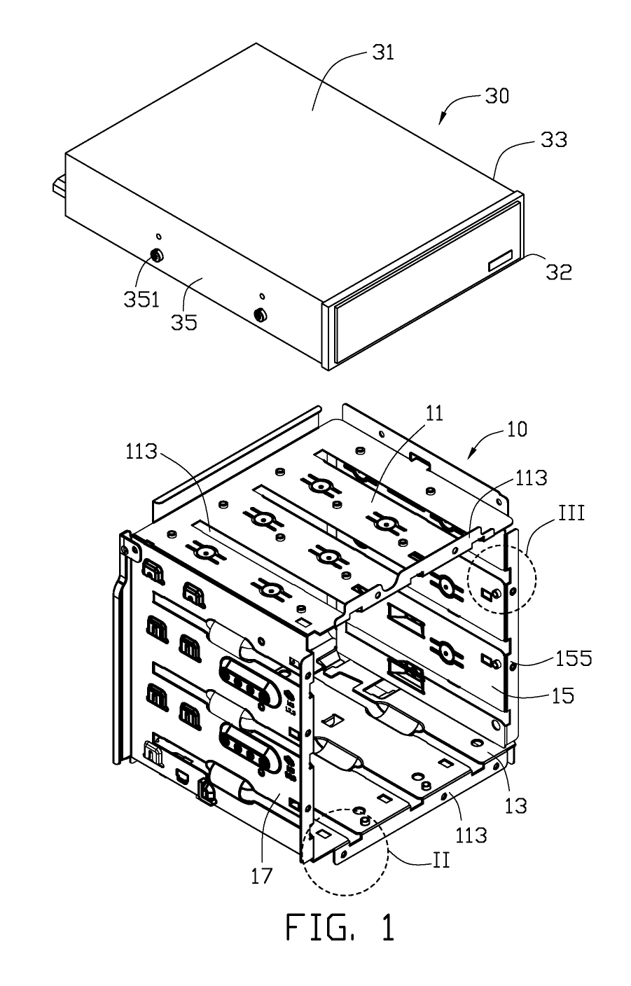

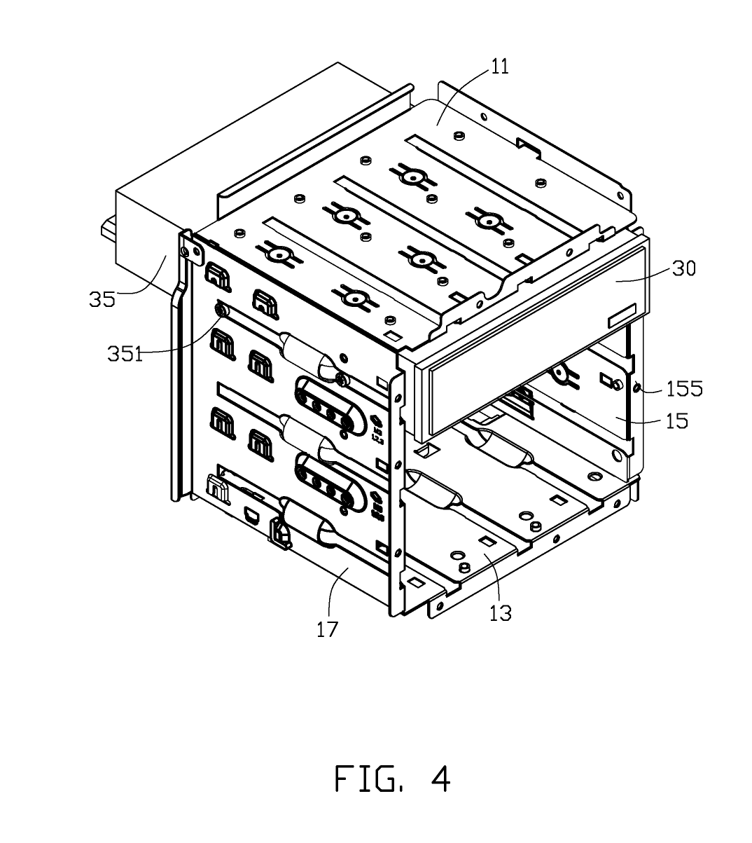

FIGS. 1 and 4 illustrate a data storage device assembly in accordance with an embodiment. The data storage device assembly includes a bracket 10 and a plurality of data storages 30. This embodiment only describes one. The data storages may include CD-ROM drives, for example.

The bracket 10 includes a top plate 11, a bottom plate 13, a first side plate 15, and a second side plate 17. The top plate 11 is substantially parallel to the bottom plate 13. The first side plate 15 and the second side plate 17 are parallel to each other and substantially connected to the top plate 11 and the bottom plate 13.

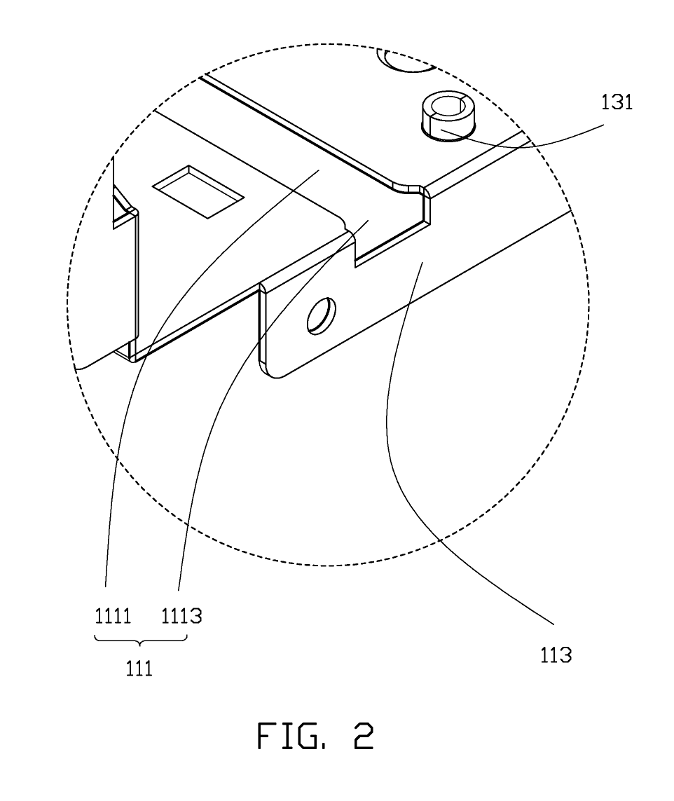

The top plate 11 and the bottom plate 13 each defines a first engaging slot 111 corresponding to the data storage 30. Each of the first engaging slot 111 (shown in FIG. 2) includes an elongated first narrow portion 1111 and a first wide portion 1113 in communicating with the first narrow portion 1111. A first positioning post 131 protrudes from the bottom plate 13, locating on one side of the first engaging slot 111 of the bottom plate 13. A first flange 113 extends outwards from each of the top plate 11 and the bottom plate 13. The first wide portion 1113 extends to the corresponding first flange 113. A third distance is defined between the first engaging slot 111 and the first positioning post 131.

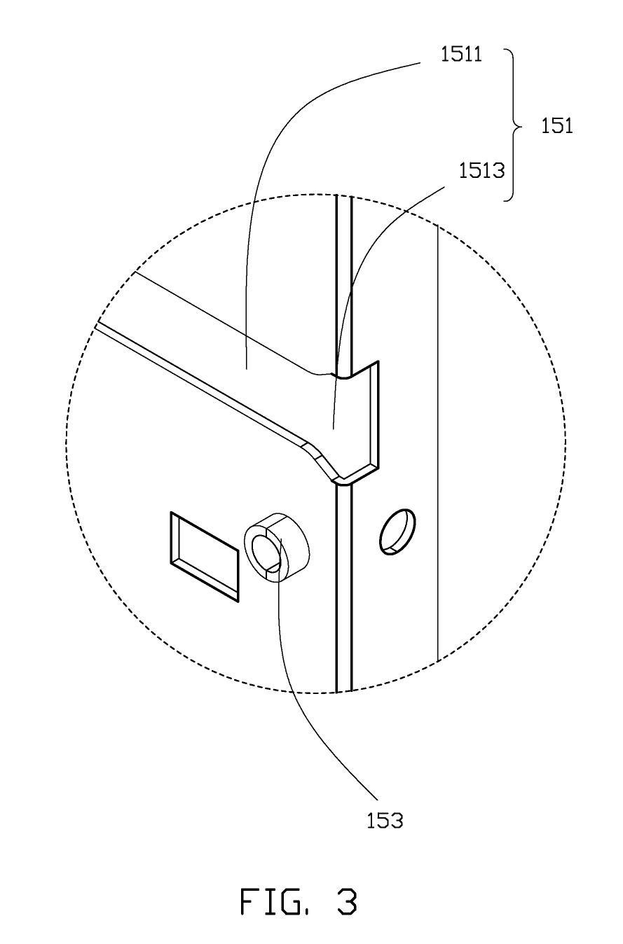

Each of the first side plate 15 and the second side plate 17 defines a second engaging slot 151 (shown in FIG. 3) corresponding to the data storage 30. Each of the second engaging slot 151 includes an elongated second narrow portion 1511 and a second wide portion in communicating with the second narrow portion 1511. A second positioning post 153 protrudes from the first side plate 15. A fourth distance is defined between the second engaging slot 151 and the second positioning post 153.

The data storage device 30 includes a top wall 31, a bottom wall 32, a first sidewall 33 and a second sidewall 35. The top wall 31 is substantially parallel to the bottom wall 32. The first sidewall 33 is substantially parallel to the second sidewall 35. Two latch portions 351 are located on each of the first sidewall 33 and the second sidewall 35. The two latch portions 351 are in line. A first distance is defined between the top wall 31 and each of the two latch portions 351, and a second distance is defined between the bottom wall 32 and each of the two latch portions 351. The first distance is greater than the second distance, and the second distance is substantially equal to the third distance and the fourth distance.

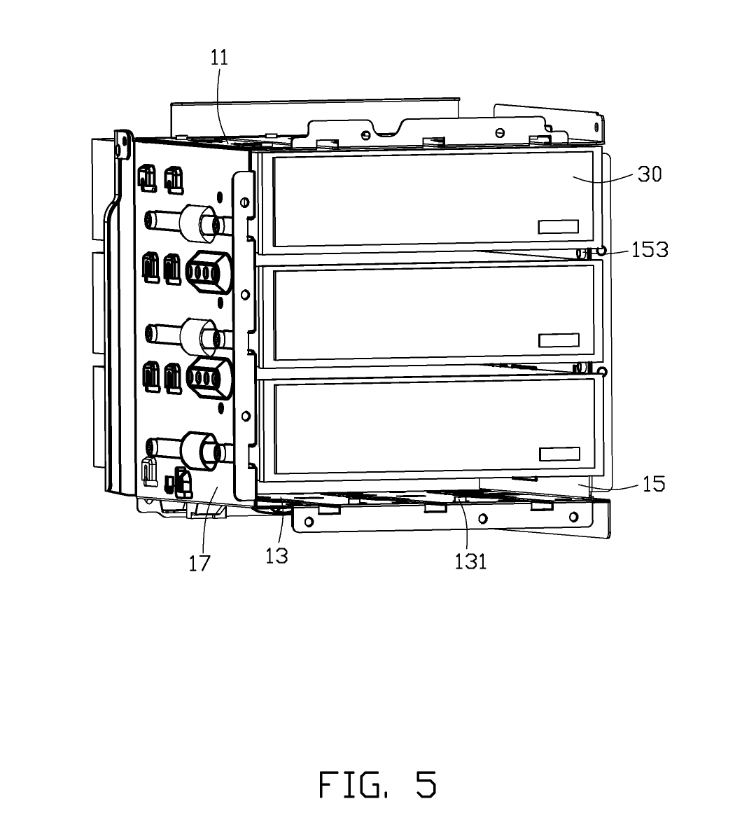

Referring to FIG. 5, when the data storage device 30 is positioned in landscape orientation, the two latch portions of the first sidewall 33 and the second sidewall 35 extend through the first wide portion 1113 of the top plate 11 and the bottom plate 13, to be slidably engaged in the first narrow portion 1111. The first positioning post 131 abuts against the bottom wall 32, to prevent the data storage device 30 from being installed in a wrong direction.

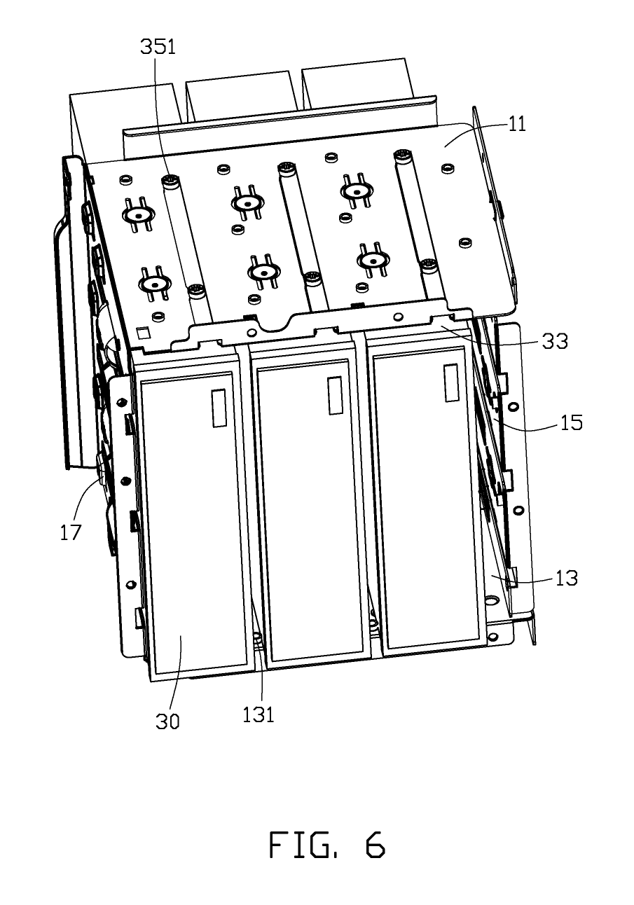

Referring to FIG. 6, when the data storage device 30 is positioned in portrait orientation, the two latch portions of the first sidewall 33 and the second sidewall 35 extend through the second wide portion 1513 of the first side plate 15 and the second side plate 17, to be slidably engaged in the second narrow portion 1511. The second positioning post 153 abuts against the bottom wall 32, to prevent the data storage device 30 from being installed in a wrong direction.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A data storage device assembly comprising:
a bracket, the bracket comprising a top plate and a bottom plate substantially parallel to the top plate; each of the top plate and the bottom plate defining a first engaging slot, a first positioning post on the bottom plate and adjacent to the first engaging slot of the bottom plate; and
a data storage device, the data storage device comprising a top wall, a bottom wall opposite to the top wall, a first sidewall and a second sidewall opposite to the first sidewall; a latch portion on each of the first sidewall and the second sidewall, a first distance being defined between the latch portion and the top wall, a second distance being defined between the latch portion and the bottom wall, and the first distance being greater than the second distance,
wherein when the data storage device is positioned in a portrait orientation, each of the latch portions is slidably engaged in each of the first engaging slots, and the first positioning post abuts against the bottom wall.

2. The data storage device assembly of claim 1, wherein a third distance is defined between the latch portion of the first sidewall and the first positioning portion, and the third distance is substantially equal to the second distance.

3. The data storage device assembly of claim 1, wherein each of the first engaging slots comprises a first narrow portion and a first wide portion interconnecting with the first narrow portion, and each of the latch portions extends through the first wide portion to engage in the first narrow portion.

4. The data storage device assembly of claim 3, wherein a first flange extends from each of the top plate and the bottom plate, and the first wide portion extends to the first flange.

5. The data storage device assembly of claim 1, wherein the bracket further comprises a first side plate and the second side plate substantially parallel to the first side plate, a second engaging slot is defined in each of the first side plate and the second side plate, and a second positioning post is located on the second side plate; when the data storage device is positioned in a landscape orientation, each of the latch portions is engaged in each of the second engaging slots, and the second positioning post abuts against the bottom wall.

6. The data storage device assembly of claim 5, wherein a fourth distance is defined between the latch portion and the second positioning post is substantially equal to the second distance.

7. The data storage device assembly of claim 5, wherein each of the second engaging slots comprises a second narrow portion and a second wide portion interconnecting with the second narrow portion, and each of the latch portions extends through the second wide portion to engage in the second narrow portion.

8. The data storage device assembly of claim 7, wherein a second flange extends from each of the first side plate and the second side plate, and the second wide portion extends to the second flange.

9. A bracket comprising:
a top plate;
a bottom plate substantially parallel to the top plate;
wherein each of the top plate and the bottom plate defines first engaging slot, a first positioning post is located on the bottom plate and adjacent to the first engaging slot of the bottom plate, the first engaging slot is configured to receive a latch portion of a data storage device, and the first positioning post is configured to abut the data storage device to secure the data storage device in a portrait orientation.

10. The bracket of claim 9, wherein each of the first engaging slots comprises a first narrow portion and a first wide portion interconnecting with the first narrow portion.

11. The bracket of claim 10, wherein a first flange extends from each of the top plate and the bottom plate, and the first wide portion extends to the first flange.

12. The bracket of claim 9, wherein the bracket further comprises a first side plate and the second side plate substantially parallel to the first side plate, a second engaging slot is defined in each of the first side plate and the second side plate, and a second positioning post is located on the second side plate; the first engaging slot is configured to receive a latch portion of the a data storage device, and the second positioning post is configured to abut the data storage device to secure the data storage device in a landscape orientation.

13. The bracket of claim 12, wherein each of the second engaging slots comprises a second narrow portion and a second wide portion interconnecting with the second narrow portion.

14. The bracket of claim 13, wherein a second flange extends from each of the first side plate and the second side plate, and the second wide portion extends to the second flange.
